(19) United States
(12) Patent Application Publication
(10) Pub. No.: US 2026/0244376 A1
(43) Pub. Date: Aug. 20, 2026

(54) NON-TRANSITORY COMPUTER-READABLE STORAGE MEDIUM STORING PRINT CONTROL PROGRAM, PRINT CONTROL APPARATUS, AND CONTROL METHOD

(71) Applicant: SEIKO EPSON CORPORATION, Tokyo (JP)

(72) Inventor: Atsushi YUMOTO, Shiojiri (JP)

(21) Appl. No.: 19/540,827

(22) Filed: Feb. 16, 2026

(30) Foreign Application Priority Data
Feb. 17, 2025 (JP) 2025-023440

(51) Int. Cl. G06F 3/12

(52) U.S. Cl. CPC G06F 3/1228; G06F 3/1203; G06F 3/1204; G06F 3/1205; G06F 3/1226; G06F 3/123; G06F 3/1236; G06F 3/1247; G06F 3/1285; G06F 3/1292

(57) ABSTRACT

A non-transitory computer-readable storage medium storing a print control program that causes a computer to function as a PSA for extending a general-purpose printer driver includes: a request generation section that generates a predetermined protocol request for transmitting a PDL; a communication data adding section that adds, to the predetermined protocol request, any communication data other than the PDL as the PDL; and a request transmitting section that transmits the predetermined protocol request to a printer.

The present application is based on, and claims priority from JP Application Serial Number 2025-023440, filed February 17, 2025, the disclosure of which is hereby incorporated by reference herein in its entirety.

### BACKGROUND

### Technical Field

The present disclosure relates to a non-transitory computer-readable storage medium storing a print control program, a print control apparatus, and a control method.

### Related Art

When an image processing apparatus such as a multifunction peripheral is controlled to process a print job, a terminal apparatus generates the print job via a dedicated printer driver installed in an operating system (OS) or a standard printer driver provided as a standard function of the OS. In general, dedicated printer drivers to be installed in an OS and used are provided by vendors of image processing apparatuses and are configured to be able to sufficiently exhibit capability of the image processing apparatuses.

On the other hand, standard printer drivers only support a function common to image processing apparatuses in many cases in order to have versatility that enables printing to be performed by many (various kinds of) image processing apparatuses. In recent years, there has been an increasing demand for print results similar to those obtained by using the dedicated printer drivers even when the standard printer drivers are used to process print jobs. In order to improve stability and security of OSs, efforts to expand the functions of standard printer drivers have been made by the vendors that provide the OSs.

As an aspect of the above-described efforts, a print support application (PSA) that supports processing of a print job by a standard printer driver is known. In general, the PSA is supplied as an application by a vendor that provides an image processing apparatus. The PSA is configured to cooperate with the standard printer driver so that functions of the image processing apparatus can be sufficiently exhibited on the basis of acquired capability information of the image processing apparatus.

The Internet printing protocol (IPP) is known as a communication protocol for transmitting and receiving a print job and necessary information between an image processing apparatus and a PSA (JP-A-2025-7856). Specifically, the PSA transmits an IPP request to the image processing apparatus, and in response to this, the image processing apparatus transmits an IPP response to the PSA. Both the IPP request and the IPP response are also referred to as IPP messages.

Each IPP message includes a version number, an operation identifier (operation ID) or a status code, a request ID, an attribute section, and a page description language (PDL). The "operation ID or a status code" is an operation ID in the case of an IPP request, and is a status code in the case of an IPP response. One of Print-Job, Get-Printer-Attributes, and Get-Jobs is designated as an operation ID of the IPP request. Print-Job is designated for the purpose of transmitting a print job from a client (PSA) to a printer (image processing apparatus). Get-Printer-Attributes is designated for the purpose of the client acquiring attribute information of the printer. Get-Jobs is designated for the purpose of the client acquiring a current job list of the printer.

When Print-Job is designated as the operation ID of the IPP request, the PDL can be added to the end of the IPP request. PDL is typically any of XML Paper Specification (XPS), Portable Document Format (PDF), Printer Command Language (PCL), and PostScript.

As described above, items that can be indicated from the PSA side to the printer side are extremely limited in the IPP. Furthermore, the same problem occurs in the case of a standard protocol, and the same problem also occurs even in the case of other standard protocols.

### SUMMARY

There is provided a non-transitory computer-readable storage medium storing a print control program that causes a computer to function as a print extension application for extending a general-purpose printer driver, the print extension application including: a request generation unit that generates a predetermined protocol request for transmitting a page description language; a communication data adding unit that adds, to the predetermined protocol request, any communication data other than the page description language as the page description language; and a request transmitting unit that transmits the predetermined protocol request to a printing apparatus.

There is provided a print control apparatus including: a general-purpose printer driver; and a print extension application that extends the general-purpose printer driver, in which the print extension application includes a request generation unit that generates a predetermined protocol request for transmitting a page description language, a communication data adding unit that adds, to the predetermined protocol request, any communication data other than the page description language as the page description language, and a request transmitting unit that transmits the predetermined protocol request to a printing apparatus.

There is provided a control method for a print control apparatus including a general-purpose printer driver and a print extension application that extends the general-purpose printer driver, the control method including: by the print extension application, generating a predetermined protocol request for transmitting a page description language; by the print extension application, adding, to the predetermined protocol request, any communication data other than the page description language as the page description language; and by the print extension application, transmitting the predetermined protocol request to a printing apparatus.

### BRIEF DESCRIPTION OF THE DRAWINGS

FIG. 1 is a block diagram of a printing system.

FIG. 2 is a functional block diagram of a computer.

FIG. 3 is a diagram illustrating, as an example, a print setting dialog by a general-purpose printer driver.

FIG. 4 is a diagram illustrating, as an example, a print setting dialog by a PSA.

FIG. 5 is a data structure diagram of an IPP message.

FIG. 6 is a control flow of the printing system.

FIG. 7 is a control flow of the printing system.

FIG. 8 is a control flow of the printing system.

FIG. 9 is a control flow of the printing system.

FIG. 10 is a control flow of the printing system.

### DESCRIPTION OF EMBODIMENTS

Although embodiments of the present disclosure will be described below, the scope of the disclosure as defined by the claims is not limited to the following embodiments. In addition, not all of the configurations described in the embodiments are essential for solving the problem. For clarity, certain descriptions and figures below are omitted or simplified as appropriate. In each drawing, the same elements are denoted by the same reference numerals, and repeated descriptions are omitted as appropriate.

The following description of embodiments will be divided into multiple sections or embodiments as needed for convenience. However, unless explicitly stated otherwise, these are not mutually independent but are related in that one may be a modified example, applied example, detailed description, or supplementary explanation, in whole or in part, of another. Additionally, when a number or the like (including a number, a value, an amount, a range, and the like) of elements is mentioned in the following embodiments, the number or the like is not limited to a specific number, for example, unless explicitly stated otherwise or unless obviously limited to the specific number in theory. The number or the like may be equal to, greater than, or less than the specific number.

Additionally, in the following embodiments, components (including operation steps and the like) are not necessarily essential, for example, unless explicitly stated otherwise or unless obviously considered to be essential in theory. Similarly, when the shape, positional relationship, or the like of a component or the like is mentioned in the following embodiments, for example, shapes or the like that are substantially approximate or similar to that shape or the like are also encompassed, for example, unless explicitly stated otherwise or unless obviously considered otherwise in theory. The same applies to the number or the like (including a number, a value, an amount, and a range) mentioned above.

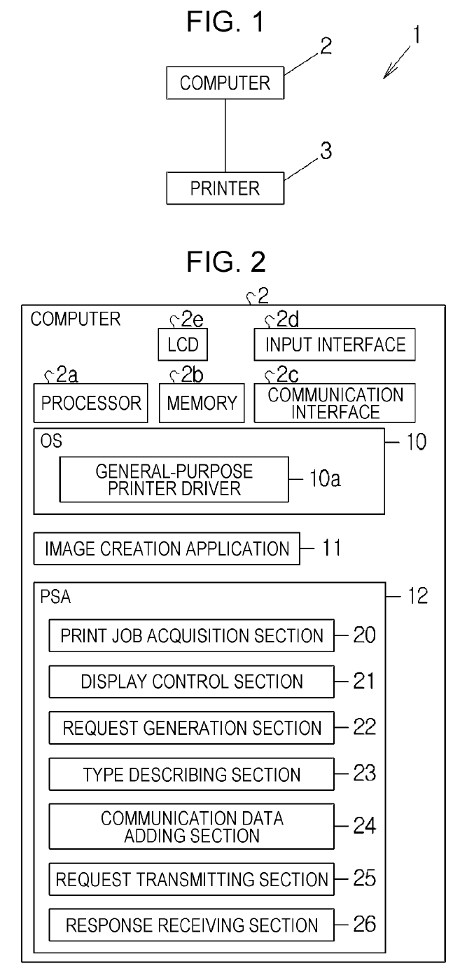

FIG. 1 is a block diagram illustrating an example of a printing system according to an embodiment of the present disclosure. A printing system 1 includes a computer 2 and a printer 3. The computer 2 and the printer 3 are configured to be able to perform bidirectional communication according to the Internet printing protocol (IPP) via a network such as a local area network (LAN) or a wide area network (WAN). Therefore, the printer 3 can also be referred to as a network printer, a cloud printer, or a shared printer when viewed from the computer 2. The computer 2 is a specific example of a print control apparatus.

FIG. 2 is a block diagram of the computer 2. As illustrated in FIG. 2, the computer 2 includes a processor 2a, a memory 2b, a communication interface 2c, an input interface 2d, and a liquid crystal display (LCD) 2e.

The input interface 2d is typically a pointing device or a keyboard. The input interface 2d may also be a touch panel overlaid on the LCD 2e.

The processor 2a is any of various types of processors, such as a central processing unit (CPU), a graphics processing unit (GPU), or a field programmable gate array (FPGA). The memory 2b is a main storage device implemented using a random-access memory (RAM) or the like, or a secondary storage device implemented using a hard disk, a solid-state drive (SSD), a memory card, a read-only memory (ROM), or the like. The processor 2a can access the memory 2b. The processor 2a communicates with the printer 3 via the communication interface 2c. The memory 2b stores programs for implementing predetermined functions. The processor 2a reads and executes the programs stored in the memory 2b. Thus, the processor 2a causes hardware such as the processor 2a, the memory 2b, and the communication interface 2c to function as an operating system (OS 10), an image creation application 11, and a print support application (PSA 12).

The image creation application 11 is a specific example of a user application. The user application is not limited to the image creation application 11 and may be a document creation application, a presentation material creation application, or a spreadsheet application. The PSA 12 is a specific example of a print extension application.

The OS 10 is basic software for controlling operations of the computer 2. Although the OS 10 may be, for example, Windows (registered trademark), the OS 10 is not limited thereto. The following description assumes that the OS 10 is Windows.

The OS 10 includes a general-purpose printer driver 10a (application programming interface). The general-purpose printer driver 10a is a printer driver that provides standard printing functions provided by Windows. The general-purpose printer driver 10a executes various kinds of processing when called by user applications such as the image creation application 11. The general-purpose printer driver 10a is installed on the computer 2 together with the OS 10. It is also possible to state that the general-purpose printer driver 10a is a printing function accompanying the OS 10. The general-purpose printer driver 10a is also called an IPP class driver.

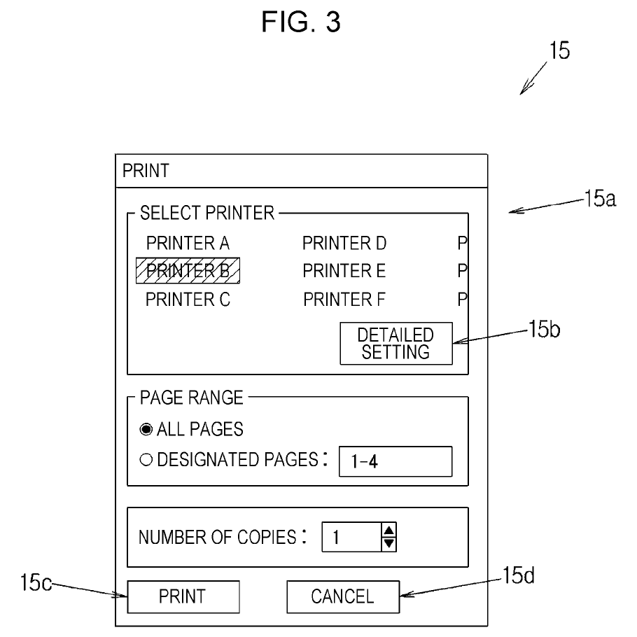

When the image creation application 11 calls the above-mentioned general-purpose printer driver 10a, the image creation application 11 converts image data created by a user using the image creation application 11 into print data in an XML Paper Specification (XPS) format or a Graphics Device Interface (GDI) format and transmits it to the general-purpose printer driver 10a. Then, the general-purpose printer driver 10a displays a standard print setting dialog 15 of Windows as illustrated in FIG. 3 on the LCD 2e. The print setting dialog 15 is also called a print dialog, a print setup dialog, a common print dialog, or a system print dialog.

In the print setting dialog 15, a print setting unit 15a, a PSA call button 15b, a print execution button 15c, and a print cancel button 15d are typically displayed.

The print setting unit 15a displays various items to allow the user to input print settings. The various items typically include a list box for selecting a printer to be used for printing, a radio button and a text box for setting a page range as a print target, a text box for setting the number of copies to be printed, and the like.

The PSA call button 15b is a button for activating the PSA 12. If the PSA call button 15b is pressed in a state where the printer to be used for printing is selected, the general-purpose printer driver 10a activates the PSA 12 corresponding to the selected printer, transmits a print job including the print data in the XPS format or the GDI format received from the image creation application 11 and the print settings set via the print setting unit 15a to the PSA 12, and closes the print setting dialog 15.

The print execution button 15c is a button for the general-purpose printer driver 10a to execute print processing.

The print cancel button 15d is a button for closing the print setting dialog 15.

Referring back to FIG. 2, the PSA 12 includes a print job acquisition section 20, a display control section 21, a request generation section 22, a type describing section 23, a communication data adding section 24, a request transmitting section 25, and a response receiving section 26. The request generation section 22 is a specific example of a request generation unit. The type describing section 23 is a specific example of a type describing unit. The communication data adding section 24 is a specific example of a communication data adding unit. The request transmitting section 25 is a specific example of a request transmitting unit. The response receiving section 26 is a specific example of a response receiving unit.

The print job acquisition section 20 acquires a print job from the general-purpose printer driver 10a when the PSA 12 is activated. The print job includes print data and print setting information. The print data is typically described in the XPS format or the GDI format.

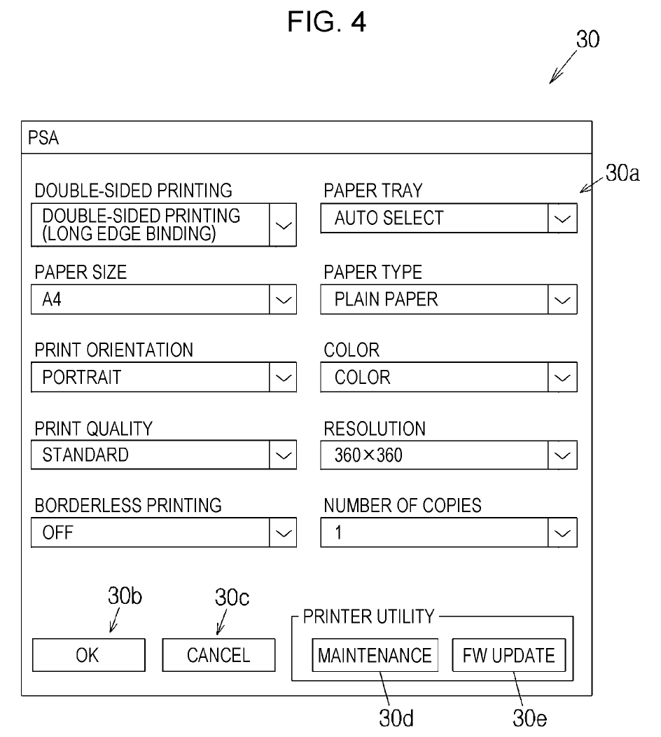

The display control section 21 displays a print setting dialog 30 as illustrated in FIG. 4 on the LCD 2e when the PSA 12 is activated. A print setting unit 30a, a print execution button 30b, a print cancel button 30c, a maintenance button 30d, and a firmware update button 30e are typically displayed in the print setting dialog 30.

The print setting unit 30a typically includes a plurality of pull-down menus so that the user can set print settings in detail. The print setting unit 30a displays more items than the number of items that can be set by the print setting unit 15a provided by the general-purpose printer driver 10a illustrated in FIG. 3.

In the present embodiment, the PSA 12 communicates with the printer 3 in accordance with the above-mentioned IPP for the following reason. Specifically, although Bidirectional (BiDi) is known as a communication standard between the computer 2 and the printer 3, the PSA 12 is not compatible with the BiDi. In addition, since the network is interposed between the computer 2 and the printer 3, it is not possible for the PSA 12 to communicate with the printer 3 without using the IPP. Therefore, the communication standard used when the printer PSA 12 communicates with the printer 3 is substantially limited to the IPP. Furthermore, all of the above-mentioned request generation section 22, the type describing section 23, the communication data adding section 24, the request transmitting section 25, and the response receiving section 26 are functional sections related to the IPP.

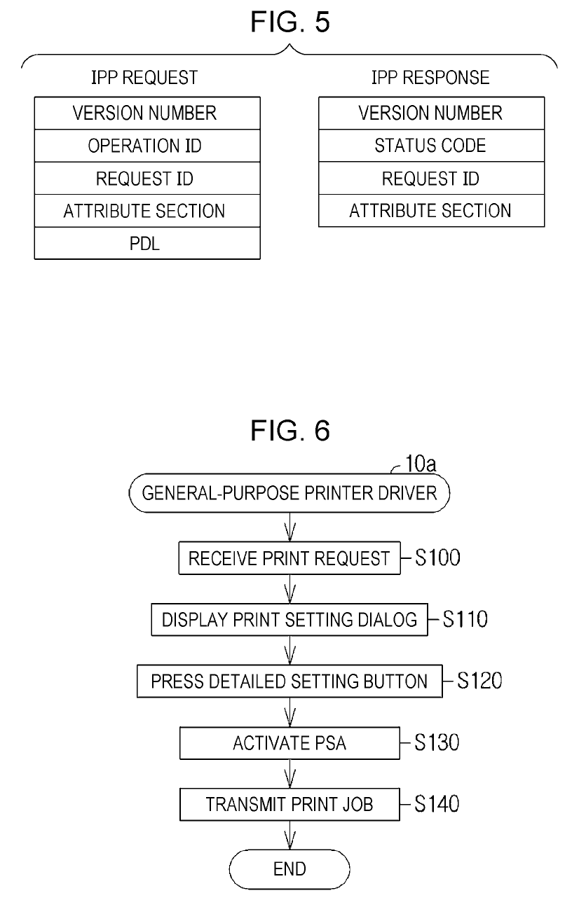

Here, a data structure of an IPP message will be described with reference to FIG. 5. The IPP message is binary data transmitted and received between the computer 2 and the printer 3 which communicate with each other in accordance with the IPP. An IPP message transmitted from the computer 2 to the printer 3 is referred to as an IPP request. An IPP message transmitted from the printer 3 to the computer 2 is referred to as an IPP response. The IPP request is an example of a predetermined protocol request, and the IPP response is an example of a predetermined protocol response.

### IPP Request

As illustrated in FIG. 5, the IPP request includes a version number, an operation ID, a request ID, an attribute section, and a page description language (PDL). The version number means a version number of the IPP standard. The operation ID is designated as any of Print-Job, Get-Printer-Attributes, and Get-Jobs. Print-Job is designated for the purpose of the PSA 12 transmitting a print job to the printer 3. Get-Printer-Attributes is designated for the purpose of the PSA 12 acquiring attribute information of the printer 3. Get-Jobs is designated for the purpose of the PSA 12 acquiring a current job list of the printer 3. The request ID is set by the PSA 12 to identify the IPP request. The attribute section has a variable length and includes a plurality of pairs each including an attribute name (key) and a value. The vendor of the PSA 12 can freely describe the attribute section. As described above, the PDL is typically any of XML Paper Specification (XPS), Portable Document Format (PDF), Printer Command Language (PCL), and PostScript. When Print-Job is designated as the operation ID, the PSA 12 can add the PDL to the end of the IPP request. On the other hand, when Printer-Attributes or Get-Jobs is designated as the operation ID, the PSA 12 cannot add the PDL to the end of the IPP request.

### IPP Response

The IPP response includes a version number, a status code, a request ID, and an attribute section. The version number means a version number of the IPP standard. A processing result corresponding to the IPP request is stored in the status code. Examples of the status code include successful-ok (normal completion), client-error-bad-request (request error), and server-error-internal-error (printer internal error). The same ID as the request ID of the corresponding IPP request is stored in the request ID. Similarly to the IPP request, the attribute section can be freely described by the vendor of the PSA 12.

In the present embodiment, any communication data other than the PDL is added as the PDL to the IPP request, thereby realizing communication with no restriction from the computer 2 to the printer 3. This will be specifically described below.

In response to the print execution button 30b, the maintenance button 30d, or the firmware update button 30e being pressed, the request generation section 22 generates an IPP request for transmitting the PDL to the printer 3. Specifically, the request generation section 22 generates an instance of the IPP request and designates Print-Job as the operation ID of the IPP request. This enables the PDL to be added to the IPP request.

The type describing section 23 describes the type of communication data to be added as the PDL to the IPP request in the attribute section of the IPP request. This enables the printer 3 having received the IPP request to easily and reliably determine the type of communication data added to the IPP request.

When a maintenance command is added as the PDL to the IPP request, for example, "document_format: maintenance_command" is described in the attribute section of the IPP request as an example. "document_format" is an attribute name, while "maintenance_command" is a corresponding value. Furthermore, when update firmware is added as the PDL to the IPP request, for example, "document_format: firmware" is described in the attribute section of the IPP request as an example. "document_format" is an attribute name, while "firmware" is a corresponding value. Furthermore, when the PDL is added to the PDL in the IPP request, for example, "document_format: pdl" is described in the attribute section of the IPP request as an example. "document_format" is an attribute name, while "pdl" is a corresponding value. Note that since the addition of the PDL to the IPP request is a method of using the IPP request originally assumed in the IPP, there is no need to describe the type of communication data again in the attribute section of the IPP request when the PDL is added as the PDL in the IPP request.

The communication data adding section 24 adds the communication data to the IPP request in response to an operation on the print setting dialog 30. Specifically, when the print execution button 30b is pressed, the communication data adding section 24 converts the print data of the print job received from the general-purpose printer driver 10a into the PDL and then adds the PDL as the PDL to the IPP request. When the maintenance button 30d is pressed, the communication data adding section 24 adds a maintenance command as the PDL to the IPP request. When the firmware update button 30e is pressed, the communication data adding section 24 adds the update firmware as the PDL to the IPP request.

The request transmitting section 25 transmits the IPP request to the printer 3. Specifically, the request transmitting section 25 transmits the IPP request to the printer 3 in a pass-through mode (PDL pass-through mode). It is thus possible to prevent the communication data added to the IPP request by the communication data adding section 24 from being processed or altered by, for example, the IPP class driver. Typically, the IPP request is typically interpreted as having been transmitted in the pass-through mode by the computer 2 or the printer 3 by specifying that the PDL is to be added to the IPP request in the attribute section of the IPP request. Note that the request transmitting section 25 may transmit the IPP request to the printer 3 without using the pass-through mode. In this case, if the communication data added as the PDL to the IPP request is not the PDL, modifying the IPP class driver to prevent the PDL from being processed or altered is conceivable.

The response receiving section 26 receives, from the printer 3, an IPP response as a response to the IPP request transmitted to the printer 3 by the request transmitting section 25. The response receiving section 26 acquires a result of processing on the printer 3 side on the basis of the description of the status code or the attribute section of the IPP response. Then, the display control section 21 displays the processing result on the printer 3 side on the LCD 2e typically in a dialog format.

Next, an operation flow of the printing system 1 will be described with reference to FIGS. 6 to 10.

First, as illustrated in FIG. 6, the general-purpose printer driver 10a receives a print request from the image creation application 11 (S100). Next, the general-purpose printer driver 10a displays the print setting dialog 15 on the LCD 2e (S110). Next, when the PSA call button 15b is pressed in the print setting dialog 15 (S120), the general-purpose printer driver 10a activates the PSA 12 (S130). Then, the general-purpose printer driver 10a transmits the print job to the PSA 12 (S140).

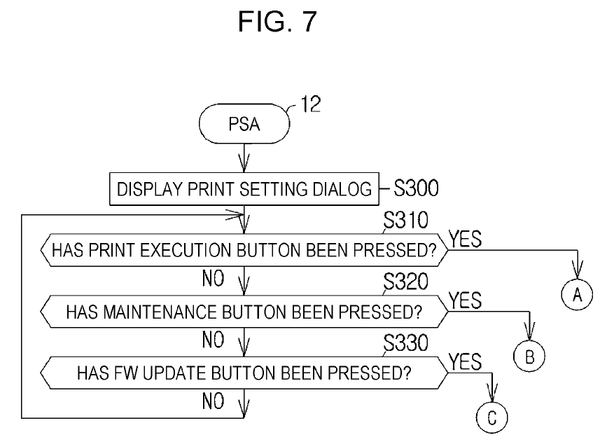

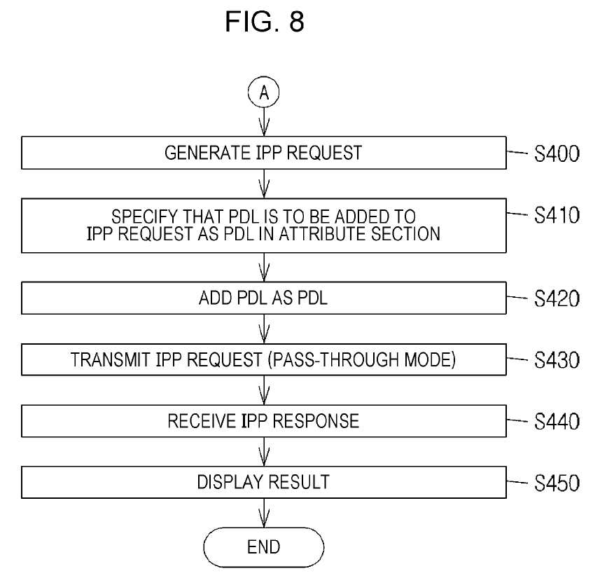

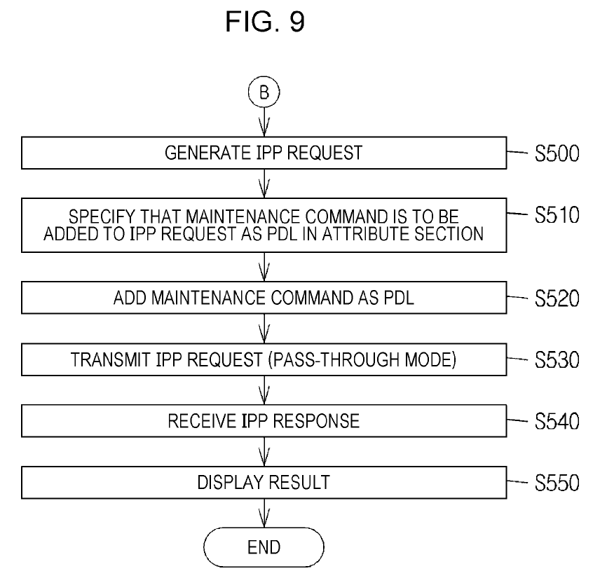

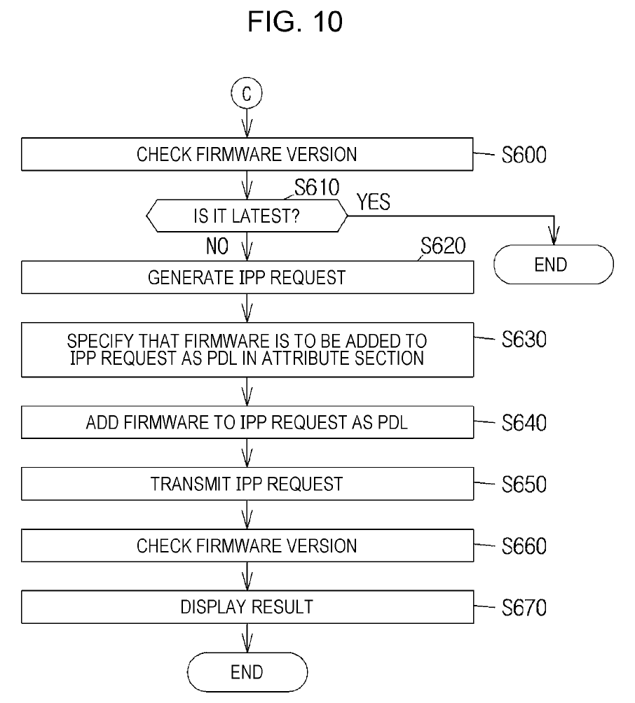

Next, as illustrated in FIG. 7, the PSA 12 displays the print setting dialog 30 on the LCD 2e (S300). Then, when the print execution button 30b is pressed (S310: YES), the PSA 12 advances the process to Step S400 in FIG. 8. When the maintenance button 30d is pressed (S320: YES), the PSA 12 advances the process to Step S500 in FIG. 9. When the firmware update button 30e is pressed (S330: YES), the PSA 12 advances the process to Step S600 in FIG. 10.

When the print execution button 30b is pressed in FIG. 7 (S310: YES), the request generation section 22 generates an IPP request for transmitting the PDL to the printer 3 as illustrated in FIG. 8 (S400). Next, the type describing section 23 specifies that the communication data to be added as the PDL in the IPP request is the PDL itself in the attribute section of the IPP request (S410). Next, the communication data adding section 24 adds the PDL itself as the PDL to the IPP request (S420). Then, the request transmitting section 25 transmits the IPP request to the printer 3 in the pass-through mode (S430). Next, the response receiving section 26 receives an IPP response from the printer 3 (S440). Then, the display control section 21 acquires the processing result on the printer 3 side on the basis of the IPP response, displays the processing result on the LCD 2e typically in a dialog format (S450), and ends the process. Typically, whether or not the printing has successfully been performed is described in the attribute section or the status code of the IPP response.

When the maintenance button 30d is pressed in FIG. 7 (S320: YES), the request generation section 22 generates an IPP request for transmitting the PDL to the printer 3 as illustrated in FIG. 9 (S500). Next, the type describing section 23 specifies that the communication data to be added as the PDL to the IPP request is a maintenance command in the attribute section of the IPP request (S510). Next, the communication data adding section 24 adds the maintenance command as the PDL to the IPP request (S520). Then, the request transmitting section 25 transmits the IPP request to the printer 3 in the pass-through mode (S530). Next, the response receiving section 26 receives an IPP response from the printer 3 (S540). Then, the display control section 21 acquires the processing result on the printer 3 side on the basis of the IPP response, displays the processing result on the LCD 2e typically in a dialog format (S550), and ends the process. When the maintenance command is a command related to nozzle cleaning, for example, whether or not the nozzle cleaning has successfully been performed is described in the attribute section or the status code of the IPP response.

When the firmware update button 30e is pressed in FIG. 7 (S330: YES), the PSA 12 designates Get-Printer-Attributes as the operation ID, generates an IPP request for requesting version information of firmware installed on the printer 3 in the attribute section, and transmits the IPP request to the printer 3, thereby checking the version of the firmware installed on the printer 3 as illustrated in FIG. 10 (S600). Next, the PSA 12 determines whether the firmware installed on the printer 3 is the latest one (S610). In the case of YES in Step S610, the PSA 12 ends the process. On the other hand, in the case of NO in Step S610, the PSA 12 advances the process to Step S620.

In Step S620, the request generation section 22 generates an IPP request for transmitting the PDL to the printer 3 (S620). Next, the type describing section 23 specifies that the communication data to be added as the PDL to the IPP request is update firmware in the attribute section of the IPP request (S630). Then, the communication data adding section 24 adds the update firmware as the PDL to the IPP request (S640). Here, the update firmware may be a file designated by the user or may be a file acquired by the PSA 12 from the server of the vendor. Next, the request transmitting section 25 transmits the IPP request to the printer 3 in the pass-through mode (S650). Next, when a predetermined period of time has elapsed, the PSA 12 designates Get-Printer-Attributes as the operation ID, generates an IPP request for requesting version information of the firmware installed on the printer 3 in the attribute section, and transmits the IPP request to the printer 3, thereby checking the version of the firmware installed on the printer 3 (S660). Then, the display control section 21 displays whether or not the firmware has successfully been updated in the printer 3 on the LCD 2e (S670) and ends the process.

The embodiments of the present disclosure have been described above, and the above embodiments have the following features.

Specifically, the print control program that causes the computer 2 to function as the PSA 12 (print extension application) that extends the general-purpose printer driver 10a includes: the request generation section 22 (request generation unit) that generates an IPP request for transmitting a page description language (PDL); a communication data adding section 24 (communication data adding unit) that adds any communication data other than the PDL as the PDL to the IPP request; and the request transmitting section 25 (request transmitting unit) that transmits the IPP request to the printer 3 (printing apparatus). According to the above-described configuration, it is possible to realize communication with no restriction from the computer 2 to the printer 3. In addition, since there is no restriction in data size of the communication data to be added as the PDL, it is possible to transmit relatively large data such as update firmware to the printer 3 without any problems.

Furthermore, the request transmitting section 25 transmits the IPP request in the pass-through mode. According to the above-described configuration, the communication data added as the PDL to the IPP request is not processed or altered before reaching the printer 3 from the PSA 12, and it is thus possible to transmit any communication data to the printer 3 without any problem.

Also, the IPP request includes an attribute section. The print control program further includes the type describing section 23 that describes the type of communication data in the attribute section. According to the above-described configuration, the printer 3 can interpret the type of communication data added as the PDL to the IPP request without any problems. However, the type describing section 23 can be omitted. In this case, it is conceivable that the printer 3 determines the type of communication data by analyzing the communication data other than the PDL added as the PDL to the IPP request. For example, the printer 3 may determine the type of communication data on the basis of the first several bytes of the communication data other than the PDL added as the PDL to the IPP request.

The print control program further includes the response receiving section 26 (response receiving unit) that receives the IPP response corresponding to the IPP request from the printer 3. The IPP response includes the attribute section. The processing result corresponding to the communication data is described in the attribute section of the IPP response. According to the above-described configuration, the PSA 12 can receive any message, that is, the processing result corresponding to the communication data, from the printer 3 through the customized attribute section. In other words, it is possible to state that free bidirectional communication between the PSA 12 and the printer 3 is realized.

Although the present disclosure has been described through the embodiments, the present disclosure is not limited to the above description. Various changes that can be understood by those skilled in the art may be made to the configurations and the details of the present disclosure within the scope of the disclosure.

In the above example, the program can be stored using various types of non-transitory computer-readable media and can be supplied to the computer. The non-transitory computer-readable media include various types of tangible storage media. Examples of the non-transitory computer-readable media include magnetic recording media (for example, a flexible disk, a magnetic tape, and a hard disk drive) and magneto-optical recording media (for example, a magneto-optical disk). Further examples of the non-transitory computer-readable media include a CD-read only memory (ROM), a CD-R, a CD-R/W, and a semiconductor memory (for example, including a mask ROM). Additional examples of the non-transitory computer-readable media include a programmable ROM (PROM), an erasable PROM (EPROM), a flash ROM, and a random-access memory (RAM). Also, the program may be supplied to the computer by various types of transitory computer-readable media. Examples of the transitory computer-readable media include an electric signal, an optical signal, and an electromagnetic wave. The transitory computer-readable media can supply the program to the computer via a wired communication channel, such as an electric wire or an optical fiber, or a wireless communication channel.

What is claimed is:

1. A non-transitory computer-readable storage medium storing a print control program that causes a computer to function as a print extension application for extending a general-purpose printer driver,
the print extension application comprising:
a request generation unit that generates a predetermined protocol request for transmitting a page description language;
a communication data adding unit that adds, to the predetermined protocol request, any communication data other than the page description language as the page description language; and
a request transmitting unit that transmits the predetermined protocol request to a printing apparatus.

2. The non-transitory computer-readable storage medium storing the print control program according to claim 1,
wherein the print extension application is a print support application.

3. The non-transitory computer-readable storage medium storing the print control program according to claim 1,
wherein the request transmitting unit transmits the predetermined protocol request in a pass-through mode.

4. The non-transitory computer-readable storage medium storing the print control program according to claim 1,
wherein the predetermined protocol request includes an attribute section, and
the print extension application further comprises a type describing unit that describes a type of the communication data in the attribute section of the predetermined protocol request.

5. The non-transitory computer-readable storage medium storing the print control program according to claim 1,
wherein the communication data is a maintenance command.

6. The non-transitory computer-readable storage medium storing the print control program according to claim 1,
wherein the communication data is update firmware of the printing apparatus.

7. The non-transitory computer-readable storage medium storing the print control program according to claim 1,
wherein the print extension application further comprises a response receiving unit that receives a predetermined protocol response corresponding to the predetermined protocol request from the printing apparatus,
the predetermined protocol response includes an attribute section, and
a processing result corresponding to the communication data is described in the attribute section of the predetermined protocol response.

8. A print control apparatus comprising:
a general-purpose printer driver; and
a print extension application that extends the general-purpose printer driver,
wherein the print extension application includes
a request generation unit that generates a predetermined protocol request for transmitting a page description language,
a communication data adding unit that adds, to the predetermined protocol request, any communication data other than the page description language as the page description language, and
a request transmitting unit that transmits the predetermined protocol request to a printing apparatus.

9. A control method for a print control apparatus including
a general-purpose printer driver, and
a print extension application that extends the general-purpose printer driver,
the control method comprising:
by the print extension application, generating a predetermined protocol request for transmitting a page description language;
by the print extension application, adding, to the predetermined protocol request, any communication data other than the page description language as the page description language; and
by the print extension application, transmitting the predetermined protocol request to a printing apparatus.
